(19) United States
(12) Patent Application Publication
(10) Pub. No.: US 2002/0151431 A1
(43) Pub. Date: Oct. 17, 2002

(54) Recovery method

(76) Inventors: Jeff Thornton, Al Huizen (NL); Arie Besemer, CC Amerongen (NL); Bas Schraven, Nymegen (NL)

Correspondence Address: William C. Rowland, BURNS, DOANE, SWECKER & MATHIS, L.L.P., P.O. Box 1404, Alexandria, VA, 22313-1404, US

(21) Appl. No.: 10/053,646

(22) Filed: Jan. 24, 2002

Related U.S. Application Data
(60) Provisional application No. 60/264,018, filed on Jan. 26, 2001.

(51) Int. Cl. B01J 31/00

(52) U.S. Cl. 502/150; 502/159

(57) ABSTRACT

The present invention relates to a method for obtaining a catalytically active mixture based on stable nitroxyl radicals. The invention is characterized in that the stable nitroxyl radicals are hydrophobic and are selectively separated from a reaction mixture by means of hydrophobic interactions.

### TECHNICAL FIELD

The present invention relates to a method for obtaining a catalytically active mixture based on stable nitroxyl radicals.

### BACKGROUND ART

It is well known in the art to use stable nitroxyl radicals such as 2,2,6,6-tetromethylpiperidin-1-oxyl (TEMPO) as catalytic oxidising agent for the selective oxidation of primary alcohols to aidehydes and/or carboxylic acids, depending on the reaction conditions chosen. Hence, this reaction has been proven to be a useful tool in the oxidation of, in particular carbohydrates having a primary alcohol function, such as for example, cellulose and starch, as well as derivatives thereof, and the like. Thus, TEMPO can be used in the production of biodegradable absorption materials.

In a process to oxidise a primary alcohol, an oxidising agent, a peracid or a salt or precursor thereof in the presence of a catalytic amount of halide is used in addition to the stable nitroxyl radicals. See for example WO 99/57158& in addition, the documents WO 00/50388 and WO 00/50463 disclose processes for oxidising primary alcohols in the presence of stable nitroxyl radicals.

Although TEMPO usually is applied in small quantities, 0.1-25 mol % with rasped to the primary alcohol, the toxicity and the relatively high price of TEMPO, and/or its analogues, cause problems. For these reasons it is desirable to recover TEMPO from reaction mixtures obtained from oxidation of primary alcohols. The document WO 96/36621 discloses a method for the recovery of stable nitroxyl radicals wherein volatile stable nitxyl radicals are distilled off by azeotropic distillation or steam distillation with water, preferably under reduced pressure.

A problem associated with the method disclosed in WO 96/36621 is that it solely can be applied to volatile nitroxyl compounds, i.e. those stable nitroxyl radicals having an appreciable vapour pressure at room temperature as for example, TEMPO. Thus, there is a need for a method to be used in the recovery of the stable nitroxyl radicals, which method is independent of the vapour pressure of the stable nitroxyl radicals.

Another problem associated with the method according to WO 96/36621 is that about 20% of the reaction volume, mainly water, needs to be distilled off to accomplish full recovery of the stable nitroxyl radicals, which gives high energy costs.

The document WO 95/07303 teaches that di-tertiaty-alkyinitroxyl can be recovered by extraction.

Accordingly, there is a need of a method for the recovery of stable nitroxyl radicals wherein the recovery can be accomplished with lower volumes and wherein less energy is required, in order to reduce the cost of production.

In addition, there is a need for a method that can be carded out at ambient pressure, regardless of the volatility of the stable nitroxyl radicals.

### DISCLOSURE OF INVENTION

In accordance with the present invention a method has been provided for the recovery of stable nitroxyl radicals, and which method eliminates the problems set out above.

A method as mentioned in the outset, and designed according to the present invention is characterized in that the stable nitroxyl radicals are hydrophobic and are separated from a reaction mixture by means of hydrophobic interactions.

In accordance with one embodiment of the method according to the present invention, the reaction mixture consists of a liquid solution.

In one embodiment of the present invention the hydrophobic interaction is an adsorption reaction wherein the stable hydrophobic nitroxyl radicals are selectively adsorbed onto a solid adsorbent exhibiting hydrophobicity, wherein the adsorbent consists of a highly porous synthetic resin selected from the group XAD-2, XAD-4, XAD8, XAD-11, XAD-16, XAD30, XAD-1180 and mixdures thereof. These Amberlite® XAD resins are available from Sigma, USA and Supelco, Bellefonte, Pa., USA.

In another embodiment of the invention silica gel (Vieselgel 60, Merck, Darmstadt, Germany) is used as a solid adsorbent onto which the hydrophobic nitroxyl radicals are selectively adsorbed.

The contacting of the reaction mixture with an adsorbent can be carried out batchwise or with the use of a column. Preferably, the invention is carried out in accordance with a chromatography process with the use of a column. By filling the column with a highly porous adsorbent (e.g. of the above mentioned kind) and then passing the reaction mixture downward through the column, the adsorbent selectively adsorbs the stable hydrophobic nitroxyl radical, while other admixtures are eliminated as effluent.

The said stable hydrophobic nitroxyl radical is eluted, desorbed, from the column by contacting the adsorbent with a solvent, said solvent comprising water, an organic solvent or a mixture thereof. Said organic solvent may comprise ethylalcohol, 1-pentanol, acetone, or tetrahydrofuran (THF). Other organic solvents, preferably miscible with water can be used as well.

If the contacting of the reaction mixture with the adsorbent is carried out batchwise, the adsorbent and the reaction mixture are mixed by shaking by hand or by stirring, whereupon the resulting mixture is filtrated. The stable hydrophobic nitroxyl radical is recovered from the filtrate by adding an organic solvent that may comprise ethylalcohol, 1-pentanol, acetone, or THF.

Other organic solvents, preferably miscible with water can be used as well.

The nitroxyl radical may be recovered from the organic solvent by evaporation, whereby the nitroxyl radical is found in the residue. It is preferable that said solvent exhibits a high vapour pressure at room temperature. A solvent which, in comparison with water, exhibits high vapour pressure and low heat of vaporisation will keep the energy consumption down and consequently, keep the energy costs down. Most of the above-mentioned solvents exhibit these features.

Hence, in this embodiment 1-pentanol can be used as a solvent, but is less preferred as it has a high boiling point (130° C.). However, in another embodiment of the invention, wherein the solution containing the stable hydrophobic nitroxyl radical and the 1-pentanol is not subjected to evaporation, but form part of the catalytically active mbdure, wherein the 1-pentanol will be oxidised to the corresponding acid and thus become soluble in the reaction mixture, 1-pertanol is a suitable solvent. This implies that 1-pentanol will not be enriched when a continuous process for recovering and re-circulating stable hydrophobic nitroxyl radicals is used, and wherein the process comprises selective oxidation of primary alchols.

However, a more preferred embodiment of the invention when 1-pentanol is used as a solvent is to use 1-pentanol as a co-solvent together with, for instance ethanol, as 1-pentanol is limitedly soluble in water. After removal of ethanol, the residue, consisting of 1-pentanol and the stable hydrophobic nitroxyl radical, can be treated as described above, i.e. form part of the catalytically active mixture.

According to one embodiment of the invention the hydrophobic interaction takes place in a precipitation step, wherein β-cyclodextin dissolved in water selectively forms complexes with the stable hydrophobic nitroxyl radicals. Preferably, a concentrated β-cyclodextrin solution is used in order to obtain a nearly quantitative recovery of the stable hydrophobic nitroxyl radicals. It is also possible to use an immobilised form of β-cyclodextrin, forming a special type of resin, comparable to the XAD-resins.

The precipitate is dissolved in a solvent, whereupon the stable hydrophobic nltroxyl radical is selectively transferred to the solvent, said solvent comprising water, an organic solvent or a mixture thereof. Said organic solvent may comprise ethylalcohol, acetone, or THF. Other organic solvents, preferably miscible with water can be used as well.

The stable hydrophobic nitroxyl radical may be recovered from the solvent by evaporation, whereby the stable hydrophobic nitroxyl radical is found in the residue. Hence, it is preferred that said solvent exhibits a high vapour pressure and a low heat of vaporisaton.

According to another embodiment of the invention the hydrophobic interaction takes place in a liquid-liquid exdraction step, wherein an organic solvent is added to the reaction mixture, and into which organic solvent the stable hydrophobic nitroxyl radicals are selectively extracted.

Suitable solvents used in the extraction step are higher primary alcohols, i.e. alcohols with C₆, or higher, such as, for example, 1-octanol.

The organic phase, comprising the stable hydrophobic nitroxyl radicals and the solvent, is recovered by physical means in a known manner, whereupon it will form part of the catalytically active mixture, wherein the water immiscible solvent will be oxidised to the corresponding acid, and thus, will become soluble at alkaline conditions. This implies that the solvent will not be enriched when a continuous process for recovering and recirculating stable hydrophobic nitroxyl radicals is used, and the process comprises selective oxidation of primary alcohols. Hence, an advantage with this embodiment is that the stable hydrophobic nltrxyl radical does not have to be stripped, i.e. back-extracted form the organic solvent as common in conventional solvent extraction which is then usually followed by a product recovery step. Nor is it necessary to evaporate or to distil the organic phase to recover the stable hydrophobic nitroxyl radicals from the organic phase.

In one embodiment of the invention the stable hydrophobic nitroxyl radical comprises TEMPO. TEMPO and its derivatives in themselves display a brownlred colour, but dissolved in an aqueous solution the solution will be yellow. However, in other instances, such as when TEMPO, and/or its derivatives, is concentrated on a column or forms complexes with cyclodextrin the presence of TEMPO is indicated by a pink colour.

In another embodiment of the invention the reaction mixture constitute an aqueous solution or an aqueous suspension.

### MODES FOR CARRYING OUT THE INVENTION

The method according to the present invention disdoses a method for obtaining a catalytically active mixture based on stable nitroxyl radicals by contacting a reaction mixture comprising the stable nitroxyl radicals with a solid phase or a liquid phase exhibiting hydrophobicity. Hydrophobicity can, for example. be found in numerous organic solvents, resins and other adsorbents, and cyclodextrins. Hence, it has been found that TEMPO, analogues and/or derivatives thereof exhibiting a hydrophobic character, can be extracted from the reaction mixture by hydrophobic interactions. These hydrophobic interactions can be utilised in a solid extraction procedure, i.e. adsorption onto a solid, in a procedure where use is made of complex formation with cyclodextrins, or in a procedure wherein a liquid-liquid extraction step is utilised.

The invention will in the following be illustrated in and by some non-limiting examples. In Example 5, 6, 7, 8, 10, 11 and 12 the absorbance was measured by means of a Pharmacia Biotech spectrometer (Ultraspec 400), using 1 cm polyactylate cuvettes at λ=425 nm.

### EXAMPLE 1

1 gram of a XADA resin was suspended in a few ml of water and then transferred to a column. 2 ml of a TEMPO solution with a concentration of 5 mg/ml was then passed through the column. After passing these 2 ml of the TEMPO solution, the column became slightly pink and the effluent became yellow. This indicates that the capacity of the XAD-4 resin is 10 mg TEMPO/g.

### EXAMPLE 2

1 gram of a XAD-16 resin was suspended in a few ml of water and then transferred to a column. 2 ml of a solution of 4-acetanmido TEMPO solution with a concentration of 5 mg/ml was then passed through the column. After passing these 2 ml of the 4-acetamido TEMPO solution, the column became slightly pink coloured and the effluent became yellow. This indicates that the capacity of the XAD-16 resin is 10 mg 4-acetamido TEMPO/g. The same result was obtained when a XAD4 resin was used instead of the XAD-16 resin.

### EXAMPLE 3

Through a column of 2 gram silica gel (Kiselgel 60, Merck) suspended in water, a solution of TEMPO (5 mg/ml) was passed. After passage of 6 ml the effluent became yellow. The TEMPO was then eluted with acetone. A quantity of 3 ml of acetone was required for the elution, and after which, the column was completely decolourised,

### EXAMPLE 4

In 100 ml of water 5 g potato starch (4.2 g in dry form) was gelatinised by heating the solution to 90° C. The solution was cooled to room temperature and then 200 mg 4-acetamido-TEMPO was added. After dissolution of this compound, 50 ml 2M sodium hypoclorite was added to the mixture, To avoid too large pH shift, the sodium hypoclorite was added in quantifies of 2 ml per time. Throughout the reaction, pH was conrlled with use of a pH-stat and by addition of 0.5 M sodium hydroxide (NaOH) pH was kept in the range from 8.5 to 9.5. The consumption of NaOH was 55 ml. The reaction mixture was concentrated to 100 ml and then brought onto a column, packed with 30 g silica gel (Kieselgel 60, Merck). The adsorption of the TEMPO-derivative onto the silica gel was observed as a yellow zone, moving slowly downward. The column was eluted with water. The 6-carboxystarch was collected in the first 150 ml of water and after passage of more water (160 ml) the 4-acetamido-TEMPO started to elute. In this fraction no G-carboxystarch could be detected, according to the colodmetric uronic acid assay of Blumenkrantz and Abdoe-Hansen, Anal. Biochem. 64, 484489 (1973). When the recovered 4-acetamido-TEMPO was used to produce 6-carboxystarch according to the description above, essentially the same result as for the starting material was obtained.

### EXAMPLE 5

To 1 g of XAD-1180 resin 2 ml of a solution of TEMPO (5 mg/ml) was added. The mixture was then stirred, resulting in decolouring of the liquid phase and colouration of the solid phase (pink). The process took less than one minute. The resulting mixdure gave an absorbance of 0.008 at λ=425 nm. The absorbance of the TEMPO solution prior mixing was 0.40 at 425 nm. After standing for about 15 minutes the mixture was filtrated. Acetone was then added to the filtrate, whereby the solution became yellow and the solid turned white. Thus, TEMPO was transferred to the solvent.

### EXAMPLE 6

The experiment performed in Example 5 was repeated with the same quantities of TEMPO but using a XAD resin instead of the XAD-1180 resin. The resulting solution gave an absorbance of 0.008 (at λ=425 nm). Accordingly, the XAD-16 resin exhibits approximately the same capacity as the XAD-1180 resin.

### EXAMPLE 7

1.0 g β-cyclodextrin was dissolved in 100 ml of water. To 10 ml of this solution, 1 ml of a solution of TEMPO (5 mg/ml) was added. The mixture was left to stand, whereby a pink precipitate was formed and the solution became colourless. The precipitate is a result of the complexation reaction of TEMPO with β-cyclodextrin. The precipitate formed is very dense, so the liquid can be decanted from the solid without appreciable loss of solid.

Two additional experiments (Experiment 2 and Experiment 3) were performed where larger amounts of TEMPO were added to the β-cycyodextrin solution, 10 mg and 15 mg, respectively, corresponding to 2 ml and 3 ml, respectively, of the TEMPO solution. The experiments were carried out in the same way as described in connection with Experiment 1.

In each experiment, the absorbance of the solution was measured both prior the complexation reaction of TEMPO with β-cyclodextrin (A₀) and after the reaction was completed (A₁). The absorbances were measured at λ=425 nm and the results are summarised in Table 1.

TABLE 1
Complex formation of TEMPO with β-cyclodextrin.

| Experiment | Amount TEMPO (mg) | Precipitate | A₀ | A₁ |
|---|---|---|---|---|
| 1 | 5 | yes | 0.050 | 0.004 |
| 2 | 10 | yes | 0.095 | 0.006 |
| 3 | 15 | yes | 0.140 | 0.028 |

In the experiments (1-3) the precipitation started after about 2-5 minutes and was effectively completed after a few hours.

Based on the assumption that 1 mol of β-cyclodextrin complexes 1 mol of TEMPO gives that 1134 mg β-cyclodexdrin complexes 156 mg of TEMPO, and thus, 1 g of β-cyclodextrin can complex 138 mg of TEMPO.

As can be seen from experiments 1 and 2 in Tab. 1. a significant amount (more than 90%) of the TEMPO formed complexes with β-cyclodextrin and precipitated. In experiment 3, 80% of TEMPO was precipitated. However, this is in accordance with the assumption made above, that only 13.8 mg of the TEMPO in experiment 3 theoretically can form complexes with β-cyclodextrin.

### EXAMPLE 8

The experiments of Example 7 were repeated but with a more diluted β-cycdodextrin solution with a concentration of 100 mg of β-cyclodexrin in 30 ml of water. The precipitation reactions in Example 8 did not start until hours after the solutions were mixed. and were completed after standing for three days, at which time the absorbances (A₁) were measured. The absorbances were measured at λ=425 nm and the results can be seen in Tab. 2.

From Tab. 2 it can be seen that the results are similar to those obtained in Example 7. However, it can be seen that the recovery of TEMPO is less efficient for diluted β-cyclodextrin solutions in comparison with the more concentrated β-cyclodextrin solutions used in Example 7. This is due to β-cyclodextrin complexes having a certain solubility in water. It should also be kept in mind that relatively high errors are associated with measurements performed on diluted systems.

The reason for the high absorbance in experiment 3 is due to the excess of TEMPO with respect to the available amount of βcyclodextrin in the solution (cf. experiment 3 in Example 7).

TABLE 2
Complex formation of TEMPO with β-cyclodextrin.

| Experiment | Amount TEMPO (mg) | precipitate | A₀ | A₁ |
|---|---|---|---|---|
| 1 | 5 | yes | 0.017 | 0.003 |
| 2 | 10 | yes | 0.031 | 0.004 |
| 3 | 15 | yes | 0.050 | 0.020 |

### EXAMPLE 9

A reaction mixture was prepared from 2 gram of oxidised starch, 100 mg of sodium bromide NaBr and 50 mg TEMPO, dissolved in 100 ml water. 2 ml of 1-octanol was added to the reaction mixture. The resulting mixture was then stirred for a few minutes, and then left to separate into two phases; a lower layer consisting of the decolourised aqueous phase, and an upper layer consisting of the organic phase, coloured dark pink The pink colour of the organic phase and the discolouration of the aqueous phase indicate that TEMPO has been transferred to the organic phase. The organic phase was added to a solution consisting of 2 gram of gelatinised starch and 100 mg NaBr. The starch indeed could be oxidised to 6-carboxystarch with sodium hypoclorite in the same way as described in Example 4 because TEMPO is transferred to the aqueous phase. The oxidation also results in the formation of octanoic acid. This is an advantage, as the 1-octanol solvent used in the extraction step will thus be removed as octanate (sodium salt) in the work-up of the reaction mixture. Hence, recovery of stable hydrophobic nitroxyl radicals by liquid-liquid extraction do not require removal of the solvent by evaporation or distillation or, as in conventional solvent extraction, where it is common to have a strip step followed by product recovery.

### EXAMPLE 10

4 ml of a solution containing 40 mg of 4-acetamido TEMPO was added to 2.0 gram of XAD-1180 resin. After stirring for a few minutes, a colourless solution and a pink solid was obtained. From spectroscopy it followed that at least 95% of the TEMPO-derivative was adsorbed onto the XAD-1180 resin. However, the obtained spectrum differed markedly from the spectrum of 4-acetamido TEMPO, indicating that an impurity was present. Thus, an adsorption higher than the measured one can be assumed.

### EXAMPLE 11

2 ml of a solution containing 20 mg 4-acetoxy-TEMPO was added to 1.0 gram of XAD-16 resin. The mixture was shaken by hand and within less than one minute the solution became decoloured and the adsorbent was coloured pink. Spectroscopy measurement gave that at least 95% of the TEMPO derivative was adsorbed onto the XAD-16 resin.

### EXAMPLE 12

Example 11 was repeated with the same resin, XAD-16, but with the TEMPO derivative 4-hydroxy-TEMPO instead of 4-acetoxy-TEMPO. Spectroscopy measurements gave that at least 95% of the TEMPO derivative 4-hydroxy-TEMPO was adsorbed onto the XAD-16 resin.

In the description above refernce has been made to TEMPO and the TEMPO derivatives 4-acetamidoTEMPO, 4-acetoxy-TEMPO and 4-hydroxy-TEMPO, but it should be understood that other suitable stable hydrophobic nitrqxyl radicals, i.e. organic nitroxyl compounds lacking ahydrogen atoms, such as 2,2,5,5-tetramethylpyrrolidine-N-oxyl (PROXYL), and derivatives thereof and those described in WO 95/07303 can be substituted for TEMPO, 4-acetamido-TEMPO, 4-acetoxy-TEMPO and 4-hydroxy-TEMPO.

Further, it should be understood that numerous other organic solvents, resins and cyclodextrins in addition to those disclosed in this application could be used for the recovery of stable hydrophobic nitroxyl radicals.

1. A method for obtaining a catalytically active mixture based on stable nitroxyl radicals characterized in that the stable nitroxyl radicals are hydrophobic and are selectively separated from a reaction mixture by means of hydrophobic interactions.

2. A method according to claim 1, wherein thereaction mixture consists of a liquid solution.

3. A method according to claim 1 or 2, wherein the hydrophobic interaction is an adsorption reaction wherein the stable hydrophobic nitroxyl radicals are selectively adsorbed onto a solid adsorbent exhibiting hydrophobicity.

4. A method according to claim 3, wherein the adsorbent consists of a hydrophobic synthetic resin.

5. A method according to claim 4, wherein the hydrophobic synthetic resin is selected from the group XAD-2, XAD4, XAD-8, XAD-11, XAD16, XAD-30, XAD-1180.

6. A method according to claim 1 or 2, wherein the hydrophobic interaction is an adsorption reaction wherein the stable hydrophobic nitroxyl radicals are selectively adsorbed onto a silica gel.

7. A method according to claim 3 or 6, wherein the said stable hydrophobic nitroxyl radical is eluted with a solvent, said solvent comprising water, an organic solvent or a mixture thereof.

8. A method according to claim 7, wherein the said organic solvent comprises ethylalcohol, aceone or THF, or a mixture of two or more of said solvents.

9. A method according to claim 7 or 8, wherein the said organic solvent is miscible with water.

10. A method according to claim 9, wherein the said organic solvent exhibits a high vapour pressure.

11. A method according to claim 7, wherein the organic solvent comprises 1-pentanol.

12. A method according to claim 1 or 2, wherein the hydrophobic interaction takes place in a precipitation step.

13. A method according to claim 12, wherein the precipitate is obtained by β-cyclodexttin selectively forming complexes with the stable hydrophobic nitroxyl radicals.

14. A method according to claim 1 or 2, wherein the hydrophobic interaction takes place in a liquid-liquid extraction step, wherein an organic solvent is added to the reaction mixture, and into which organic solvent the stable hydrophobic nitroxy radicals are selectively transferred.

15. A method according to claim 14, wherein the organic solvent comprises alcohols with C₆ or higher.

16. A method according to claim 15, wherein the organic solvent comprises 1-octanol.

17. A method according to any one of the preceding claims, wherein the method is used in a continuous process for recirculating stable hydrophobic nitroxyl radicals.

18. A method according to claim 16, wherein the process comprises selective oxidation of primary alcohols.

19. A method according to any one of the preceding claims, wherein the stable hydrophobic nitroxy radical is TEMPO.

20. A method according to any one of the preceding claims, wherein the reaction mature consfitutes an aqueous solution or an aqueous suspension.
